(19) United States
(12) Patent Application Publication
(10) Pub. No.: US 2025/0258650 A1
(43) Pub. Date: Aug. 14, 2025

(54) Apparatus and Method for Generating True Random Number

(71) Applicant: Nanjing Jugong Technology Co., Ltd., Nanjing City (CN)

(72) Inventors: Yin Chen, Nanjing City (CN); Qingzhao Qian, Nanjing City (CN)

(21) Appl. No.: 18/856,938

(22) PCT Filed: Apr. 18, 2023
(86) PCT No.: PCT/CN2023/089024

§ 371 Date: Oct. 15, 2024

(30) Foreign Application Priority Data
Apr. 18, 2022 (CN) CN202210401983.4
Jul. 26, 2022 (CN) CN202210887783.4

(51) Int. Cl. G06F 7/58

(52) U.S. Cl. CPC G06F 7/588

(57) ABSTRACT

Provided are an apparatus and method for generating a true random number. Since a random number generation edge node is made of a large number of transparent materials and can support an information security auditing function, a high-credibility and auditable true random number can be visually generated. Since a plurality of random number generation edge nodes can be deployed in cities in different regions at the same time, power networks and communication networks are not shared. Intelligent software and hardware devices are used to generate random numbers automatically and rapidly, so true random numbers can be reliably, quickly, massively and neutrally generated for a long time. As a random number generation center node can provide a true random number seed generation service for all the public by means of a public interface, a random number generation service can be conveniently used at a low cost for a single user.

### TECHNICAL FIELD

The present disclosure relates to the technical field of the generation of true random numbers, and in particular to that the generated true random number is used for lotteries or sweepstakes.

### BACKGROUND

The openness, fairness and impartiality of the lotteries or sweepstakes are mainly determined by the list of participants, random seeds and the algorithm for calculating the lottery results according to the random seeds and the list of participants (hereinafter referred to as the lottery algorithm). At present, the openness, fairness, justice and tamper proofness of the list of participants and the lottery algorithm can be achieved by previous evidence preserving through the blockchain. However, how to generate the true random number seeds with high credibility, low cost, ease of use and auditability intuitively, reliably, quickly, massively and neutrally is a difficult problem. For example, although the random.org website has provided a rapid and massive generation of true random numbers based on thunderstorm noise, the public cannot intuitively supervise and audit the generation process of the random numbers (worried that the platform generates random numbers selectively), which affects the openness and credibility of lotteries and sweepstakes. In the Wutong chain blockchain notarization lottery used by Suzhou notary office, an encryption card is used to generate random number seeds, the public cannot intuitively supervise and audit the generation process of random numbers (worried that the Wutong chain platform generates random numbers selectively), which affects the openness and credibility of the lotteries or sweepstakes. Although China sports lottery and China welfare lottery provide an intuitive random number generation process, due to the slow generation speed, less generated numbers and high cost, the public cannot take the initiative to visit offline at any time (worried that the live-streaming video of the lottery is recorded and faked), and no stable random number generation API (Application Programming Interface) (which is not easy to be used as random seeds in daily lottery or sweepstake activities) is provided, and then the needs of the lottery or sweepstake for the openness, credibility, ease of use and rapid generation of a large number of random seeds cannot be satisfied. Some lottery or sweepstake activities can generate the random number seeds for lottery or sweepstake by directly using block generation information of the blockchain system, which has the problems of being manipulated by miners, not intuitive enough and not credible.

### SUMMARY

An embodiment of the present disclosure provides an apparatus and method for generating a true random number, thus solving the technical problem that high-credibility, low-cost, easy-to-use and auditable true random number seeds cannot be generated intuitively, reliably, quickly, massively and neutrally during lottery or sweepstake.

In a first aspect, an apparatus for generating a true random number provided by an embodiment of the present disclosure is used for generating the true random number, including more than one random number generation edge nodes, and one random number generation center node. A housing of each random number generation edge node is made of a transparent material and placed in a public place, and internally includes: more than one transparent containers; one or more randomly movable objects arranged in the transparent container; an electromechanical device configured to control the randomly movable objects periodically; one or more video surveillance cameras configured to capture an internal operation situation and an external environment situation of the random number generation edge node; one or more display devices configured to display the internal operation situation and the external environment situation of the random number generation edge node; and an edge server coupled to the video surveillance camera and the display device. The edge server is configured to generate random numbers automatically and periodically based on one or more images periodically captured by the one or more video surveillance cameras, automatically identify internal and external operation situations of the random number generation edge node, send data to the random number generation center node, save video surveillance data, control the display device, and broadcast live video to the public. The randomly movable objects include ping-pong balls with numbers printed thereon. The electromechanical device includes an electric fan, a stepping motor, a switch sensor, an electrostatic removal component, and a programmable industrial control mainboard. The electromechanical device is configured to rearrange the randomly movable objects periodically and randomly by blowing air to the bottom of the transparent container. The edge server is configured to support information security auditing. The random number generation center node is configured to support the information security auditing, and the electromechanical device is controlled by the edge server. Each of the edge server supporting information security auditing and the random number generation center node is configured with a log storage function for inputting and outputting information, a log storage function for executing a command, and a function for protecting system information security. The random number generation center node for periodically generating the random number information according to the preset rules is configured with a function for generating data with a time point and a list of random numbers according to a moment when the random number generation center node receives the data, a serial number of the random number generation edge node, a serial number of the transparent container, and the random number generated by the transparent container. The edge server for generating the random number periodically and automatically based on one or more images periodically captured by one or more video surveillance cameras is configured with an artificial intelligence model which is trained using a machine learning system based on a neural network and used for automatically identifying an operating status of the random number generation edge node, as well as related control software codes. The edge server is configured to automatically identify the random number through the artificial intelligence model, the related control software codes and received snapped pictures.

In a second aspect, a method for generating a true random number provided by an embodiment of the present disclosure includes the following steps: generating a random number periodically and automatically by more than one random number generation edge nodes which are made of a transparent material and located in a public place; sending data related to random number generation to a random number generation center node by each random number generation edge node; and periodically generating random number information by the random number generation center node according to the received data and preset rules, and opening the generated random data information to the public. A method for automatically generating the random number by the random number generation edge node includes the following steps: rearranging one or more randomly movable objects in a transparent container randomly through the periodic operation of an electromechanical device; periodically capturing, by one or more video surveillance cameras, pictures of the rearranged randomly movable objects, and sending the pictures to an edge server; automatically identifying, by the edge server, corresponding random numbers according to information of received snapped pictures; sending, by the edge server, the identified random numbers to the random number generation center node; controlling, by the edge server, a display device to display an internal operation situation and an external environment situation of the random number generation edge node, saving video surveillance data, and broadcasting live video to the public. The randomly movable objects include ping-pong balls with numbers printed thereon. A method for periodically operating the electromechanical device includes periodically blowing air to the bottom of the transparent container by the electromechanical device which is connected to an electric fan, a stepping motor, a switch sensor, an electrostatic removing component and a programmable industrial control mainboard to rearrange the randomly movable objects periodically and randomly. The edge server is configured to support information security auditing; and the random number generation center node supports information security auditing, and the electromechanical device is controlled by the edge server. A method for periodically generating the random number information according to the preset rules includes generating data with a time point and a list of random numbers according to a moment when the random number generation center node receives the data, a serial number of the random number generation edge node, a serial number of the transparent container, and the random number generated by the transparent container. A method for automatically identifying random numbers by the edge server according to information of snapped pictures includes the following steps: training an artificial intelligence model for automatically identifying an operating status of the random number generation edge node using a machine learning system based on a neural network; and installing the artificial intelligence model and related control software codes to the edge server, where the edge server is configured to automatically identify random numbers through the artificial intelligence model, the relevant control software codes and the received snapped pictures. A method for supporting the information security auditing includes a log storage function for inputting and outputting information, a log storage function for executing commands, and a function for protecting system information security.

An apparatus and method for generating the true random number provided by the present disclosure have the following beneficial effects: as the housing of the random number generation edge node is made of a transparent material and placed in the public place, and a container in the transparent material for scrolling and rearranging randomly movable objects is also transparent, the display device in the apparatus can display internal and external operating environment situations in real time. The random number generation edge node can provide live streaming service to the public, and the random number generation edge node and the random number generation center node can support the information security audit function. Therefore, by actively visiting and supervising offline and watching live streaming online by participants in the lottery activities at the same time and validating the process of producing the random number seeds online and the process of producing the random number seeds offline in a cross manner, the problems of tampering with random seeds by recorded broadcasting or video fraud can be solved. Then, highly credible and auditable true random numbers can be intuitively generated. Since multiple random number generation edge nodes can be simultaneously deployed in cities in different regions (the cities in different regions do not chare the power networks and the communication networks), and intelligent software and hardware devices are used to generate random numbers automatically and rapidly, no one participates in the operation of the related devices in the whole process, and the true random numbers can be reliably, quickly, massively and neutrally generated for a long time. Since the random number generation center node can provide a true random number seed generation service for all the public by means of a public interface, the random number generation service can be conveniently used at a low cost for a single user.

### BRIEF DESCRIPTION OF THE DRAWINGS

The accompanying drawings, which constitute a part of the present disclosure, are used to provide a further understanding of the present disclosure, and the illustrative embodiments of the present disclosure and their descriptions are used to explain the present disclosure, and do not constitute an undue limitation of the present disclosure. In the drawings:

FIG. 1 is a structural diagram of an apparatus according to the present disclosure;

FIG. 2 is a schematic diagram of a random number generation edge node according to the present disclosure;

FIG. 3 is a flow diagram according to the present disclosure;

FIG. 4 is a schematic diagram of a random number generation device according to the present disclosure.

### DETAILED DESCRIPTION OF THE EMBODIMENTS

To make those skilled in the art understand the technical solutions of the present disclosure better, the technical solutions in the embodiment of the present disclosure will be described clearly and completely with the accompanying drawings in the embodiment of the present disclosure. Apparently, the described embodiments are merely a part rather than all of the embodiments of the present disclosure. All other embodiments obtained by those of ordinary skill in the art based on the embodiments of the present disclosure without creative efforts shall fall within the scope of protection of the present disclosure. The terms “first” and “second” in the specification and claims of the present disclosure and the above accompanying drawings are used to distinguish similar objects, rather than describing a particular order or precedence. It should be understood that the data used can be interchanged under appropriate circumstances, such that the embodiments described herein can be implemented in other orders than those illustrated or described herein. Moreover, the terms “include”, “contain” and any other variants mean to cover the non-exclusive inclusion. For example, a process, method, system, product, or device including a series of steps or units is not necessarily limited to those explicitly listed, but may include other steps or units not explicitly listed or inherent to these processes, methods, products, or devices.

This embodiment provides an apparatus and method for generating a true random number. FIG. 1 is a structural diagram of an apparatus provided by this embodiment. As shown in FIG. 1, the structure diagram includes a random number generation edge node 101 and a random number generation edge node 102 for information transmission and exchange with a random number generation center node 103 through a network.

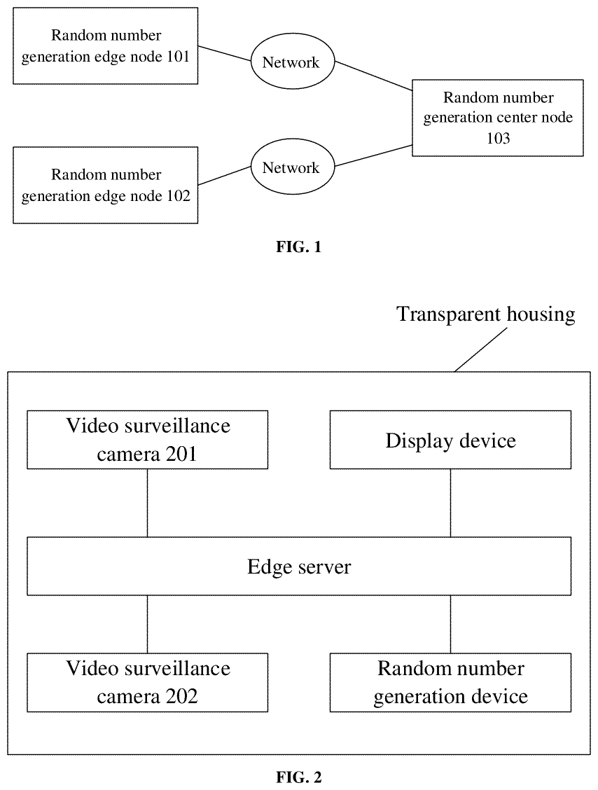

FIG. 2 is a schematic diagram of a random number generation edge node apparatus in FIG. 1. As shown in FIG. 2, the schematic diagram includes a housing of the random number generation edge node made of a transparent glass material, and the housing is sized to be easily placed and displayed in a public place, and it is easy for people in the public place to watch an internal operating situation of the random number edge node. The random number generation edge node internally includes a random number generation device composed of a container customized by transparent glass, 12 ping-pong balls printed with different numbers in the transparent container, an electric fan, a stepping motor, an electrostatic removal component, a switch sensor and a programmable industrial control mainboard (shown in FIG. 4); a video surveillance camera 202 configured to capture an internal operating situation and an external environment situation of the random number generation edge node; a video surveillance camera 201 configured to capture details of random movements of the ping-pong balls; a display device configured to display the internal operating situation and the external environment situation of the random number generation edge node; and an edge server coupled to the video surveillance camera and the display device.

The edge server in FIG. 2 is a general-purpose computer device, which is configured to generate a random number periodically and automatically based on images periodically captured by the video surveillance camera 201, and identify internal and external operating statuses of the random number generation edge node periodically and automatically based on the images periodically captured by the video surveillance camera 202. Software function of automatically identifying random numbers and the internal and external operating statuses of the random number generation edge node according to images is achieved using a mainstream artificial intelligence model trained by a machine learning system based on a neural network in the market, and related control software codes. The method for training the artificial intelligence model includes inputting a proper amount of labels and a large number of pictures with object labels into the machine learning system for training to obtain the artificial intelligence model with an object detection based on the pictures.

The edge server in FIG. 2 is configured to send data to the random number generation center node in FIG. 1 every minute, store video surveillance data 24 hours a day, control the display device, and broadcast a live video to the public. The data sent to the random number generation center node includes: a moment when the random number is identified, a serial number of the random number generation edge node, a serial number of the transparent glass container, the random number generated by the identified transparent glass container with the corresponding serial number, and the BASE64 code corresponding to the identified picture. The content displayed by the display device includes: the random numbers generated every minute, an internal operating status and an external environment status of the random number generation edge node (including live-streaming video information of nearby visitors in video monitoring), and time-sensitive data obtained from the network in real time (e.g., real-time stock trading data and news live-streaming information of authoritative TV stations). The method of broadcasting the live video is achieved by pushing a video stream to a WeChat live video platform using open-source OBS studio software.

The edge server in FIG. 2 is configured to support information security auditing, which is specifically configured with a log storage function for inputting and outputting information, a log storage function for executing a command, and a function for protecting system information security. The function related to information security auditing is achieved through the cooperation of hardware and software on the computer device. The mainstream information security auditing software and hardware in the market can be purchased and installed on the edge server.

As shown in FIG. 4, a container customized by the transparent glass, 12 ping-pong balls printed with different numbers, an electric fan, a stepping motor, an electrostatic removal component, a switch sensor and a programmable industrial control mainboard can be assembled. A bottom groove of the container customized by the transparent glass has a width of 5 cm, a length of 50 cm, and a depth of 10 cm. The middle part of the container customized by the transparent glass forms an included angle of 5 degrees from the horizontal plane, which facilitates the ping-pong balls to slide into the groove. Moreover, a grounded red copper sheet with a width of 1 cm, a length of 50 cm and a height of 0.2 mm is placed on an inner wall of the groove, or at the bottom of the inner wall of the groove, thereby eliminating the static electricity generated by the long-term random movement of the ping-pong balls. The numbers of the ping-pong balls are different, including numbers from 1 to 12. Eighteen identical numbers with the same size are uniformly printed on the same ping-pong ball, such that the number on the ping-pong ball can be captured by the camera no matter how the ping-pong moves. C9003 type miniature brushless centrifugal blower produced by Ningbo Anchor-drive Technology Co., Ltd. is employed as the electric fan. The standard closed-loop 57 type stepping motor on the market is employed as the stepping motor. The fan is fixed to the stepping motor through an optical axis fixing seat. An infrared photoelectric switch sensor is employed as the switch sensor. The programmable industrial control mainboard is configured to: drive the electric fan to blow air to an air inlet at the bottom of the transparent container for 10 seconds at the zero second of every minute, making the ping-pong ball move randomly at an upper part of a leaky-groove shaped transparent glass container; drive the stepping motor to rotate at the 10^{-th} second of every minute, and rotate the electric fan installed on the stepping motor for 30 degrees counterclockwise, thus rapidly cutting off the air from the air inlet of the transparent container; and drive the stepping motor to rotate at the 20^{-th} second of every minute, and rotate the electric fan installed thereon for 30 degrees clockwise, making a tuyere of the electric fan re-aligned with the air inlet of the transparent container to make preparations for random number generation in the next minute cycle. The switch sensor below the fan is used for automatic resetting of the tuyere of the fan after accidental power failure and power supply recovery. The programmable industrial control mainboard can drive the tuyere of the electric fan on the stepping motor to align with the bottom of the transparent container by identifying a switch signal of the switch sensor.

For simplicity of FIG. 2 and FIG. 4 and easy understanding of related technologies by those of ordinary skill in the art, FIG. 2 does not show multiple transparent glass containers and multiple sets of corresponding electromechanical devices. Those skilled in the art of the electromechanical device can achieve the connection of multiple sets of electromechanical devices with reference to FIG. 2 and FIG. 4. In practical application, more than two transparent glass containers and more than two sets of corresponding electromechanical devices need to be configured to ensure the operation reliability of a single random number generation edge node. The edge server in FIG. 2 is configured to control the electromechanical device, including: when the edge server identifies that the ping-pong balls in a transparent glass container with a certain serial number cannot move normally and randomly according to the collected pictures, the electromechanical device with the corresponding serial number is enabled to stop operating by controlling the programmable industrial control mainboard; and when the device with a certain serial number is stopped, it is attempted to start another set of redundant electromechanical device to continue operation.

The random number generation center node 103 in FIG. 1 is configured to receive data from two random number generation edge nodes, generate random number information every minute according to the preset rules, and send the data in JSON format to the public through a HTTPS (Hypertext transfer protocol) communication protocol. The preset rules include generating the random number information according to the sequence of the serial numbers of the random number generation edge nodes and the sequence of the serial numbers of the transparent containers. The random number information includes: a moment when the random number generation center node receives the data, the serial number of the random number generation edge node, the serial number of the transparent container, the random number generated by the transparent container, a sorted list of permutations and combinations of the numbers of the ping-pong balls, a list of decimal coded numbers corresponding to the sorted list of permutations and combinations of the numbers of the ping-pong balls, and the random numerical range.

A method in which the random number generation center node 103 is configured to support the information security auditing in FIG. 1 is similar to the method in which the edge server is configured to support the information security auditing in FIG. 2.

For simplicity of FIG. 2 and FIG. 4 and easy understanding of related technologies by those of ordinary skill in the art, FIG. 2 does not show some necessary but easily inferred device apparatuses and connections, such as a lighting device with reasonable brightness, a power supply device with reasonable power, a cable with a reasonable connection, a network device with a reasonable connection, and a network connection.

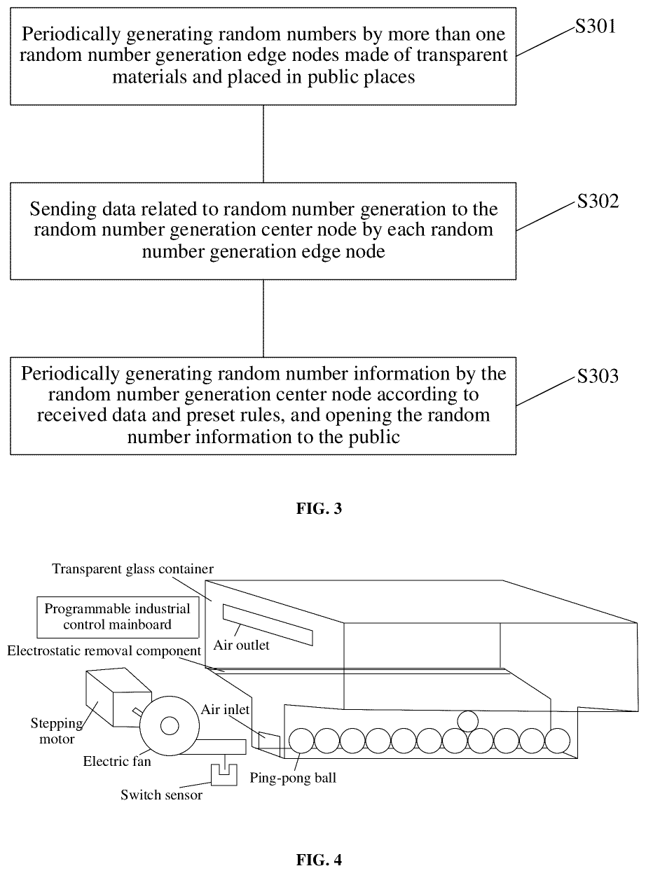

In the following, the flow diagram in FIG. 3 and the above apparatus are used to describe how to generate the true random number.

Firstly, as shown in S301 in FIG. 3, a random number generation edge node device apparatus shown in FIG. 2 is placed in a commercial plaza with a large human traffic in Beijing, numbered as 1001, and internally provided with two sets of transparent glass containers and electromechanical devices numbered as 10011 and 10012 respectively. A random number generation edge node apparatus shown in FIG. 2 is placed in a park plaza with a large human traffic in Shanghai, numbered as 2001, and internally provided with two sets of funnel-shaped transparent glass containers and electromechanical devices numbered as 20011 and 20012, respectively. At 19:02:00 on Apr. 17, 2022, electric fans of four sets of random number generation devices blow air into the bottom air inlets of their respective transparent containers at the same time, making the ping-pong balls in the transparent glass moved randomly for 10 seconds. At 19:02:10 on Apr. 17, 2022, the electric fans of the four sets of random number generation devices are moved counterclockwise for 30 degrees at the same time, thus stopping the air inlets at the bottoms of the transparent containers and rearranging four sets of ping-pong balls in the transparent glass to the bottoms of the transparent glass containers. At 19:02:20 on Apr. 17, 2022, the electric fans of the four sets of random number generation devices are moved clockwise for 30 degrees at the same time at the same time, and the video surveillance camera 201 in FIG. 2 is configured to send a picture snapped at this time to the edge server.

As shown in S302 in FIG. 3, the edge server in the random number generation edge node numbered as 1001 sends the random number information in JSON data format automatically identified and generated by artificial intelligence to the random number generation center node deployed in Alibaba Cloud through HTTPS communication protocol at 19:02:22 on Apr. 17, 2022. The content of the random number information is as follows: {“nodeNo”:“1001”,“time”:“2022-04-17-19-02”,“datas”:[{“genNo”:“10011”,“pingpongNo”:“100107020809110504031206”,“img”:“base64fo rmatImg-01-moreDataNotShow”},{“genNo”:“10012”,“pingpongNo”:“040305100711020809010612”,“img”:“ base64formatImg-02-moreDataNotShow”}]}. The edge server in the random number generation edge node numbered as 1002 sends the random number information in JSON data format automatically identified and generated by artificial intelligence to the random number generation center node deployed in Alibaba Cloud through HTTPS communication protocol at 19:02:23 on Apr. 17, 2022. The content of the random number information is as follows:

{“nodeNo”:“1002”,“time”:“2022-04-17-19-
02”,“datas”:[{“genNo”:“20011”,“pingpongNo”:“070812020510030911040601”,“img”:“base64fo
rmatImg-03-
moreDataNotShow”},{“genNo”:“20012”,“pingpongNo”:“090501070612020310041108”,“img”:“
base64formatImg-04-moreDataNotShow”}]}.

As shown in S302 in FIG. 3, the random number generation center node generates random number information from the received data according to the sequence of the serial numbers of the edge nodes and the serial numbers of the containers. The content of the random number information is as follows: {“time”:“2022-04-17-19-02”,“pingpongNos”:[“1b 100107020809110504031206”,“040305100711020809010612”,“07081202 0510030911040601”,“090501070612020310041108”],“randomNos”:[“361089176”,“127994581”,“264598774”,“334030334”],“maxValue”:479001599,“nodes”:[{“nodeNo”:“1001”,“time”:“2022-04-17-19-02”,“datas”:[{“genNo”:“10011”,“pingpongNo”:“100107020809110504031206”,“img”:“base64fo rmatImg-01-moreDataNotShow”},{“genNo”:“10012”,“pingpongNo”:“040305100711020809010612”,“img”:“ base64formatImg-02-moreDataNotShow”}]},{“nodeNo”:“1002”,“time”:“2022-04-17-19-02”,“datas”:[{“genNo”:“20011”,“pingpongNo”:“070812020510030911040601”,“img”:“base64fo rmatImg-03-moreDataNotShow”},{“genNo”:“20012”,“pingpongNo”:“090501070612020310041108”,“img”:“ base64formatImg-04-moreDataNotShow”}]}]}. PingpongNos field is the sorted list of permutations and combinations of the numbers of the ping-pong balls, randomNos field is a list of decimal coded numbers corresponding to the sorted list of permutations and combinations of the numbers of the ping-pong balls, and max Value field is the maximum possible range of the random numbers starting from 0. The method for converting the number permutation of the ping-pong balls into a corresponding decimal code includes defining the number permutation of the ping-pong balls from 1 ascending to 12 as decimal code 0, and defining the number permutation of the ping-pong balls from 12 descending to 1 as decimal code 479001599, and calculating various combinations as the corresponding decimal codes through the permutation and combination methods and computer algorithm. For example, a ping-pong ball permutation 100107020809110504031206 can be divided into 12 segments, and the number of permutations and combinations between the segments can be calculated respectively, and finally added. All permutations between 010203040506070809101112 (inclusive) and 100102030405060708091112 (exclusive) may be 359251200=(10-1)*11*10*9*8*7*6*5*4*3*2. All permutations between 100102030405060708091112 (inclusive) and 100102030405060708091112 (exclusive) may be 0-(1-0-1)*10*9*8*7*6*5*4*3*2. All permutations between 100102030405060708091112 (inclusive) and 100107020304050608091112 (exclusive) may be 1814400-(7-1-1)*9*8*7*6*5*4*3*2. All permutations between 100107020304050608091112 (inclusive) and 100107020304050608091112 (exclusive) may be 0-(2-1-1)*8*7*6*5*4*3*2. All permutations between 100107020304050608091112 (inclusive) and 100107020803040506091112 (exclusive) may be 20160=(8-3-1)*7*6*5*4*3*2. All permutations between 100107020803040506091112 (inclusive) and 100107020809030405061112 (exclusive) may be 2880=(9-4-1)*6*5*4*3*2. All permutations between 100107020809030405061112 (inclusive) and 100107020809110304050612 (exclusive) may be 480=(11-6-1)*5*4*3*2. All permutations between 100107020809110304050612 (inclusive) and 100107020809110503040612 (exclusive) may be 48=(5-2-1)*4*3*2. All permutations between 100107020809110503040612 (inclusive) and 100107020809110504030612 (exclusive) may be 6=(4-2-1)*3*2. All permutations between 100107020809110504030612 (inclusive) and 100107020809110504030612 (exclusive) can be 0=(3-2-1)*2. All permutations between 100107020809110504030612 (inclusive) and 100107020809110504031206 (exclusive) may be 1=(12-10-1). All permutations between 100107020809110504031206 (inclusive) and 100107020809110504031206 (inclusive) may be 1=6-5, and finally, all permutations may be 361089176=359251200+0+1814400+0+20160+2880+480+48+6+0+1+1. In addition, multiple identical numbers with the same size should be printed on the same ping-pong ball such that the camera can identify the number on the ping-pong ball. The public can obtain the random number information in JSON format at 19:02:30 on Apr. 17, 2022 through the HTTPS communication protocol and the preset network address.

At 19:03:00 on Apr. 17, 2022, a new cycle is started. The random number generation edge node automatically rearranges the ping-pong balls through the random number generation device, and the edge server automatically identifies the generated random numbers based on the pictures snapped at 19:03:20 on Apr. 17, 2022 and sends the generated random numbers to the random number generation center node. The random number generation center node generates the latest random number information according to the preset rules and open the random number information to the public. Therefore, the true random numbers used for lottery or sweepstake are continuously generated in a cycle every minute.

In addition, it should be noted that the above functions of storing the video surveillance data, broadcasting the live video to the public, displaying the content of the display device, auditing the information security, and opening a network random number query interface to the public operate 24 hours a day and are not affected by the above processes. Specific method for live-streaming the videos and displaying the content by the display device have been described when describing the apparatus 20, and thus will not be described in detail here. The function of information security audit is mainly to protect the data security of random number generation edge node and random number generation center node, prevent illegal network access and attacks, and facilitate the public security and judicial departments for evidence collection and auditing.

A method for using the generated true random number seeds for lottery or sweepstake includes: storing the information such as the list of people participating in lottery or sweepstake, the number of winners or prize setting, information of a moment when random number seeds are generated in the future, an algorithm for generating lottery or sweepstake results, etc. in the a blockchain system in advance; and when the random number seeds at a specified time point are generated, generating a highly credible lottery or sweepstake result using the information stored in the blockchain system.

The above embodiments are only preferred embodiments of the present disclosure, and are not intended to limit the present disclosure. limiting. It should be noted that although the present disclosure has been described in detail with reference to the foregoing embodiments, those of ordinary skill in the art should understand that it is still possible to modify the technical solutions described in the foregoing embodiments, or to replace some or all technical features with equivalents. However, these modifications or replacements do not make the essence of the corresponding technical solutions deviate from the spirit and scope of the technical solutions of various embodiments of the present disclosure.

What is claimed is:

1. An apparatus for generating a random number, comprising more than one random number generation edge nodes, and one random number generation center node;
a housing of each random number generation edge node is made of a transparent material and placed in a public place, and internally comprises more than one transparent containers; one or more randomly movable objects arranged in the transparent container; an electromechanical device configured to control the randomly movable objects periodically; one or more video surveillance cameras configured to capture an internal operation situation and an external environment situation of the random number generation edge node; one or more display devices configured to display the internal operation situation and the external environment situation of the random number generation edge node; and an edge server coupled to the video surveillance camera and the display device, wherein the edge server is configured to generate random numbers automatically and periodically based on one or more images periodically captured by the one or more video surveillance cameras, automatically identify internal and external operation situations of the random number generation edge node, send data to the random number generation center node, save video surveillance data, control the display device, and broadcast live video to the public;
the random number generation center node is configured to receive data of more than one random number generation edge nodes, periodically generate random number information according to preset rules, and open the generated random number information to the public.

2. The apparatus according to claim 1, wherein the randomly movable objects comprise ping-pong balls with numbers printed thereon; the electromechanical device comprises an electric fan, a stepping motor, a switch sensor, an electrostatic removal component, and a programmable industrial control mainboard; the electromechanical device is configured to rearrange the randomly movable objects periodically and randomly by blowing air to the bottom of the transparent container; the edge server is configured to support information security auditing; and the random number generation center node is configured to support the information security auditing, and the electromechanical device is connected to the edge server.

3. The apparatus according to claim 2, wherein each of the edge server supporting information security auditing and the random number generation center node is configured with a log storage function for inputting and outputting information, a log storage function for executing a command, and a function for protecting system information security.

4. The apparatus according to claim 1, wherein the random number generation center node for periodically generating the random number information according to the preset rules is configured with a function for generating data with a time point and a list of random numbers according to a moment when the random number generation center node receives the data, a serial number of the random number generation edge node, a serial number of the transparent container, and the random number generated by the transparent container.

5. The apparatus according to claim 1, wherein the edge server for generate the random number periodically and automatically based on the one or more images periodically captured by the one or more video surveillance cameras is configured with an artificial intelligence model which is trained using a machine learning system based on a neural network and used for automatically identifying an operating status of the random number generation edge node, as well as related control software codes; and the edge server is configured with a function for automatically identifying the random number through the artificial intelligence model, the related control software codes and received snapped pictures.

6. A method for generating a true random number, comprising the following steps: generating a random number periodically and automatically by more than one random number generation edge nodes which are made of a transparent material and located in a public place; sending data related to random number generation to a random number generation center node by each random number generation edge node; and periodically generating random number information by the random number generation center node according to the received data and preset rules, and opening the generated random data information to the public;
a method for automatically generating the random number by the random number generation edge node comprises the following steps: rearranging one or more randomly movable objects in a transparent container randomly through the periodic operation of an electromechanical device; periodically capturing, by one or more video surveillance cameras, pictures of the rearranged randomly movable objects, and sending the pictures to an edge server; automatically identifying, by the edge server, corresponding random numbers according to information of received snapped pictures; sending, by the edge server, the identified random numbers to the random number generation center node; controlling, by the edge server, a display device to display an internal operation situation and an external environment situation of the random number generation edge node, saving video surveillance data, and broadcasting live video to the public.

7. The method according to claim 6, wherein the randomly movable objects comprise ping-pong balls with numbers printed thereon; a method for periodically operating the electromechanical device comprises periodically blowing air to the bottom of the transparent container by the electromechanical device which is connected to an electric fan, a stepping motor, a switch sensor, an electrostatic removing component and a programmable industrial control mainboard to rearrange the randomly movable objects periodically and randomly; the edge server is configured to support information security auditing; and the random number generation center node supports information security auditing, and the electromechanical device is controlled by the edge server.

8. The method according to claim 6, wherein a method for periodically generating the random number information according to the preset rules comprises generating data with a time point and a list of random numbers according to a moment when the random number generation center node receives the data, a serial number of the random number generation edge node, a serial number of the transparent container, and the random number generated by the transparent container.

9. The method according to claim 6, wherein a method for automatically identifying random numbers by the edge server according to information of snapped pictures comprises the following steps: training an artificial intelligence model for automatically identifying an operating status of the random number generation edge node using a machine learning system based on a neural network; and installing the artificial intelligence model and related control software codes to the edge server, wherein the edge server is configured to automatically identify random numbers through the artificial intelligence model, the relevant control software codes and the received snapped pictures.

10. The method according to claim 7, wherein a method for supporting the information security auditing comprises a log storage function for inputting and outputting information, a log storage function for executing a command, and a function for protecting system information security.
